(19) United States
(12) Patent Application Publication
(10) Pub. No.: US 2006/0191703 A1
(43) Pub. Date: Aug. 31, 2006

(54) Electric conductor assembly, device comprising an electrical component connected to the conductor assembly and connection system comprising an assembly of this type

(75) Inventors: Francois Charrier, Arcon (FR); Didier Bisson, Doubs (FR)

Correspondence Address: HARRINGTON & SMITH, LLP, 4 RESEARCH DRIVE, SHELTON, CT, 06484-6212, US

(73) Assignee: FCI Expansion 2

(21) Appl. No.: 11/265,551

(22) Filed: Nov. 1, 2005

(30) Foreign Application Priority Data
Nov. 2, 2004 (FR) 04 11 663

(51) Int. Cl. H02G 3/04

(52) U.S. Cl. 174/68.1

(57) ABSTRACT

This electric conductor assembly includes an electric conductor in the form of a plate having a first surface and a second surface and comprising an aperture which extends through the conductor between these surfaces, and first and second spacing members which are supported on the first surface and the second surface at the periphery of the aperture. The assembly includes centering means for centering and immobilising the first and second spacing members radially relative to the aperture. Used in the production of electrical supply circuits, in particular for trains or motor vehicles.

The present invention relates to an electric conductor assembly, of the type comprising:

an electric conductor in the form of a plate having a first surface and a second surface and comprising an aperture which extends through the conductor between these surfaces along an axis,

a first spacing member which is supported on the first surface at the periphery of the aperture, and

a second spacing member which is supported on the second surface at the periphery of the aperture.

Conductors of this type are used in particular in electrical power connection systems, for example, in order to supply electricity for electrically driven motor vehicles or railway vehicles.

These systems comprise a plurality of conductor assemblies of the above-mentioned type arranged close to each other. The apertures serve to connect and fix terminals of electrical components to the various conductors.

During operation, the conductors are brought to different voltages. Insulators which cover the surfaces of the conductors prevent the formation of electric arcs between the conductors.

The insulators are generally provided with openings in the region of the apertures. In order to provide an electrical contact surface between the conductors and the components, the openings of an insulator are larger than the corresponding apertures of a conductor and leave, on the surface of the conductor, a support zone exposed between the aperture and the insulator.

Document EP-A1-0 993 083 describes a conductor assembly of the above-mentioned type.

During assembly, a spacing member may move into abutment with the edge of the insulator at the periphery of a support zone.

In order to prevent this risk, one solution consists in providing very large exposed support zones which have an outer diameter which is much greater than that of the spacing members.

However, the larger the exposed support zones are, the greater the risk of electric arcs being formed between the conductors.

An object of the present invention is to provide an electric conductor assembly which allows the risks of electric arcs being formed to be limited.

To this end, the invention proposes an electric conductor assembly of the above-mentioned type, characterised in that it comprises centering means for centering and immobilising the first and second spacing members radially relative to the aperture.

According to other embodiments, the electric conductor assembly comprises one or more of the following features, taken in isolation or according to all technically possible combinations:

the centering means comprise a portion of the second spacing member that protrudes from the aperture at the side of the first surface, the first spacing member being engaged on the portion;

the first spacing member is fitted on an outer surface of the portion;

the first spacing member is force-fitted on the portion;

the portion has a shape which complements that of the aperture and extends through the aperture in order to allow the second spacing member to be centered relative to the aperture;

the portion of the second spacing member is force-fitted in the aperture;

the conductor, the second spacing member and the first spacing member form a fixedly joined assembly;

it comprises at least one insulator which covers a surface of the conductor, the insulator having an opening in the region of the aperture and providing an exposed support zone between the aperture and the insulator, the spacing member which is supported on the surface moving into abutment with this exposed support zone;

the opening has a diameter which is substantially equal to or greater than the diameter of the spacing member;

the centering means allow the spacing members to be immobilised in terms of rotation about the axis, relative to each other and relative to the aperture,

the maximum resistance torque relative to the rotation of the centering means of the spacing members is greater than 15 N.m.

The invention further relates to an electrical device comprising an assembly as defined above, and a tie rod which extends axially through the spacing members, a support washer which is held in abutment with either the first or the second spacing member by the tie rod, and an electrical component which is held in abutment with the other of the first or second spacing member.

The invention further relates to an electrical connection system comprising a plurality of electric conductor assemblies as defined above.

The invention will be better understood from a reading of the following description, given purely by way of example and with reference to the appended drawings, in which:

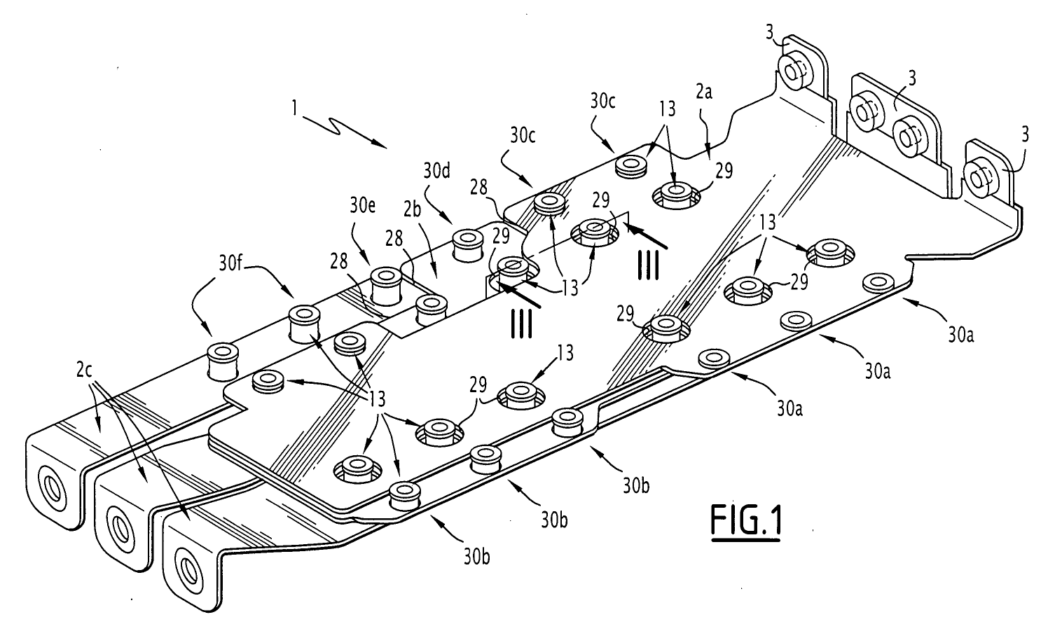

FIG. 1 is a perspective view of an electrical connection system comprising a plurality of superimposed conductor assemblies;

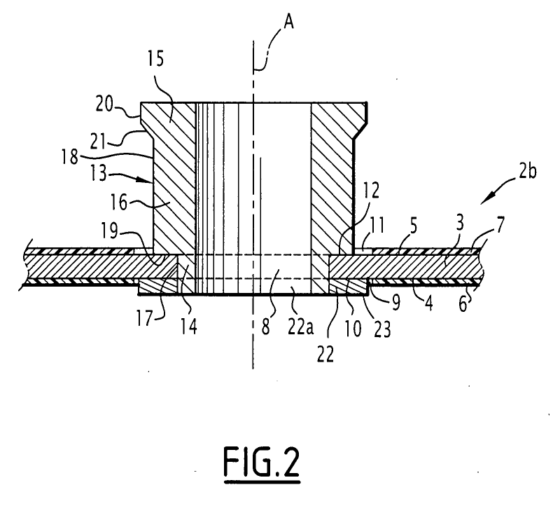

FIG. 2 is a sectioned view of a conductor assembly of the connection system;

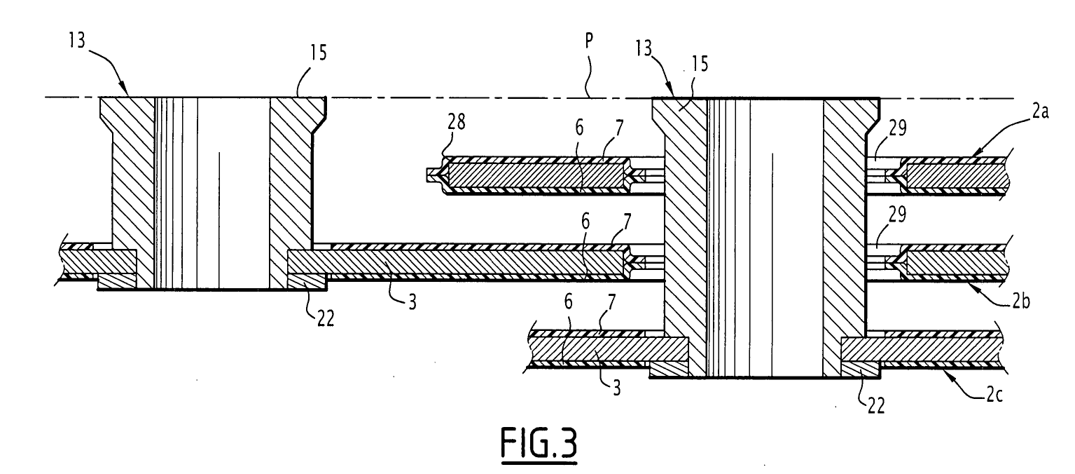

FIG. 3 is a partial sectioned view taken along III-III of the connection system illustrating a plurality of superimposed conductor assemblies;

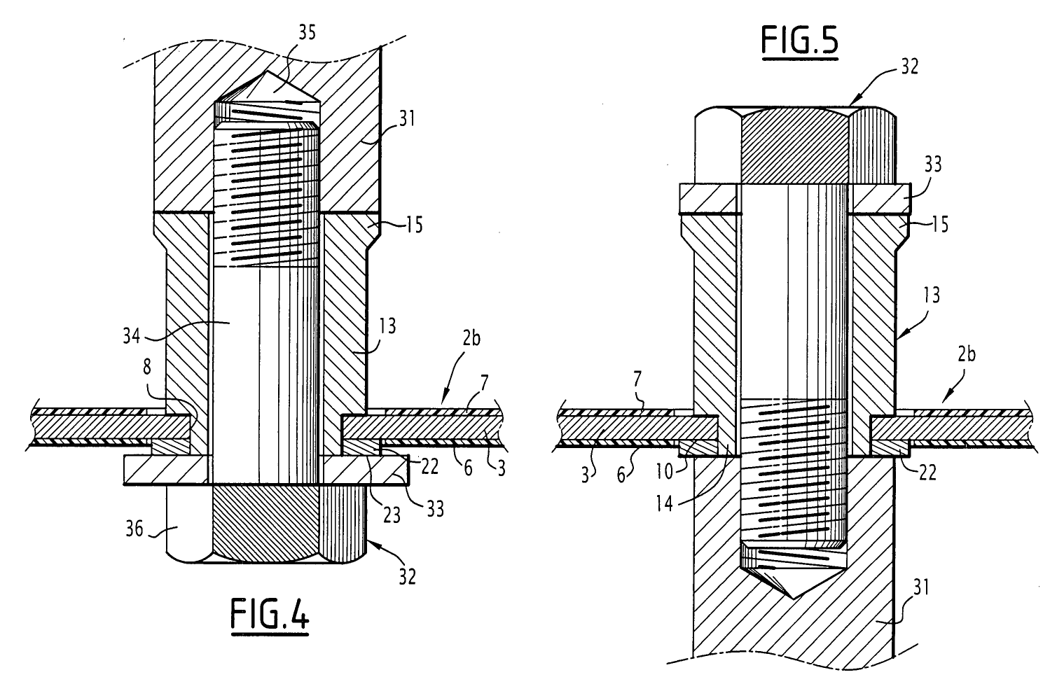

FIG. 4 is a view similar to FIG. 2, with an electrical component fixed to the conductor assembly according to a first variant; and

FIG. 5 is a Figure similar to FIG. 2, with an electrical component fixed to the conductor assembly according to a second variant.

As illustrated in FIG. 1, an electrical connection system 1 comprises a plurality of electric conductor assemblies 2a, 2b, 2c of the bus bar type. These conductor assemblies 2a, 2b, 2c are all in the form of a plate and are superimposed.

The electrical connection system 1 is used to produce electric circuits, for example, for supplying electric energy to devices such as railway vehicles or motor vehicles. More generally, the electrical connection system is used for any system for transmission of electric energy.

More precisely, the system 1 comprises an upper conductor assembly 2a, an intermediate conductor assembly 2b which is arranged below the upper conductor assembly 2a, and three lower conductor assemblies 2c which are arranged in the same plane, below the intermediate conductor assembly 2b.

The electric conductor assemblies 2a, 2b, 2c have identical structures. Only the structure of an intermediate conductor assembly 2b is described in detail below, with reference to FIG. 2.

The intermediate conductor assembly 2b comprises a plate-like conductor 3, opposed first surface 4 and second surface 5 of which are covered by insulating films 6, 7.

The intermediate conductor assembly 2b is provided with electrical connection means for electrical components.

To this end, the conductor 3 has an aperture 8 which extends through the conductor 3 and which opens in the region of the first surface 4 and the second surface 5.

The first insulator 6 is provided with an opening 9 which is located in the region of the aperture 8. That is to say, the opening 9 is centred relative to the aperture 8. The opening 9 is larger than the aperture 8 and leaves a first annular support zone 10 exposed on the first surface 4, between the aperture 8 and the insulator 6.

The second insulator 7 is provided with an opening 11 which is also centred on the aperture 8. The opening 11 is larger than the aperture 8 and leaves a second annular support zone 12 exposed on the second surface 5, between the aperture 8 and the second insulator 7.

A small column or connector 13 is fixed in the aperture 8. The connector 13 which is generally of tubular cylindrical form, has a first axial end 14 which is received in the aperture 8 and a second opposing axial end 15. The connector 13 has a central portion 16 axially between the first end 14 and the second end 15. The central portion 16 and the second end 15 protrude relative to the plane of the conductor assembly 2b at the side of the second surface 5.

The connector 13 has a smooth cylindrical inner bore which delimits an axial passage in the connector 13 and a stepped cylindrical outer surface.

More precisely, the first end 14 has a cylindrical outer surface 17 having a smaller diameter than that of the outer surface 18 of the central portion 16 and a radial shoulder 19 connects these outer surfaces 17, 18. Furthermore, the second end 15 has an outer surface 20 having a larger diameter than that of the outer surface 18 of the central portion 16, and these outer surfaces 20, 18 are connected by means of a frustoconical shoulder 21 which widens at the side of the second end 15.

The outer surface 17 of the first end 14 has a shape which complements that of the aperture 8. The first end 14 is pushed with force into the aperture 8 of the conductor 3 at the side of the second surface 5, the radial shoulder 19 being supported axially on the second support zone 12 of the second surface 5. The first end 14 of the connector 13 constitutes a means for centering the connector 13 relative to the aperture 8.

The second support zone 12 has an outer diameter which is greater than the outer diameter of the outer surface 18 of the central portion 16 of the connector 13. Consequently, the radial shoulder 19 does not move into abutment with the second insulator 7 and is not at risk of damaging it.

The first end 14 of the connector 13 is axially larger than the aperture 8, so that a distal portion of the first end 14 protrudes from the aperture 8 at the side of the first surface 4 of the conductor 3.

An annular spacing member 22 is fitted on the outer surface 17 of the protruding portion of the first end 14, and is supported on the first support zone 10. The spacing member 22 is thicker than the insulator 6 and forms, at the side facing away from the conductor 3, an annular support zone 23 which is raised relative to the insulator 6.

The spacing member 22 has a central hole 22a. The spacing member 22 is force-fitted on the outer surface 17 of the protruding portion of the first end 14.

The protruding portion of the first end 14 and the spacing member 22 have the same axial dimensions, so that the first end 14 does not protrude from the raised support zone 23 but instead is flush therewith.

The first end 14 and the central hole 22a constitute complementary centering means between the spacing member 22 and the connector 13. The spacing member 22 is centred on the connector 13 and, consequently, relative to the aperture 8 since the connector 13 is centred on the aperture 8. The spacing member 22 is therefore immobilised and cannot move radially relative to the main axis A of the aperture 8.

The connector 13, the conductor 3 and the spacing member 22 form a fixedly joined assembly. This prevents the spacing member 22 and the connector 13 from becoming disengaged or being removed by an operator.

The connector 13 forms a second spacing member which is taller than the spacing member 22.

With reference to FIG. 1 again, the electric conductor assemblies 2a, 2b, 2c are all provided with a plurality of connectors 13 as described above. The connectors 13 of the different electric conductor assemblies 2a, 2b, 2c all extend in the same direction, upwards in FIG. 1. In a variant, the connectors 13 extend in different directions, for example, opposite directions.

The upper conductor assembly 2a and the intermediate conductor assembly 2b are both formed so as to allow the passage of the connectors 13 carried by the conductor assemblies 2b, 2c that they cover.

To this end, the upper conductor assembly 2a and the intermediate conductor assembly 2b are each provided with cut-out edges 28 and holes 29.

The connectors 13 are arranged in four parallel rows of six connectors 13 which define twelve pairs of connectors 13. The two connectors 13 of each pair are fixed to different conductor assemblies 2a, 2b, 2c in order to connect electrical components of the dipolar type between these two conductor assemblies 2a, 2b, 2c being considered.

In the example illustrated, three pairs 30a allow the connection between the upper conductor assembly 2a and a first lower conductor assembly 2c, three pairs 30b allow the connection between the intermediate conductor assembly 2a and the first lower conductor assembly 2c, two pairs 30c allow the connection between the upper conductor assembly 2a and a second lower conductor assembly 2c, a pair 30d allows the connection between the intermediate conductor assembly 2b and the second lower conductor assembly 2c, a pair 30e allows the connection between the intermediate conductor assembly 2b and a third lower conductor assembly 2c, and two pairs 30f allow the connection between the upper conductor assembly 2a and the third lower conductor assembly 2c.

The connectors 13 have different axial lengths depending on whether they are carried by the upper conductor assembly 2a, the intermediate conductor assembly 2b or one of the lower conductor assemblies 2c so that the second ends 15 of the connectors 13 are located in the same plane P (FIG. 3) located above the level of the upper conductor assembly 2a.

As illustrated in FIG. 3, a first connector 13 carried by the intermediate conductor assembly 2b extends through a recess which is provided by a cut-out edge 28 of the upper conductor assembly 2a.

A second connector 13 carried by a lower conductor assembly 2c extends through aligned holes 29 which are provided in the intermediate conductor assembly 2b and the upper conductor assembly 2a.

The second ends 15 of the connectors 13 are located in the same plane, indicated with a dot-dash line P in FIG. 3.

As can be seen in FIG. 3, the insulators 6, 7 of each conductor assembly 2a, 2b, 2c join in the region of the edges 28 and through the holes 29 in order to cover and thereby insulate each conductor.

With reference to FIG. 2, since the spacing member 22 associated with the aperture 8 is radially immobile, the first insulator 6 may have an opening 9 having a diameter which is substantially equal to but slightly greater than the outer diameter of the spacing member 22, and may cover the first surface 4 of the conductor 3 closest to the spacing member 22 in order to provide effective electrical insulation, limiting the risk of an electric arc being formed between the conductor 3 and another conductor.

In particular, this covering prevents the appearance of electric arcs, referred to as tracking arcs, which are propagated over the outer surface of the insulators along tracking lines, between the exposed conductor elements. The closer to the spacing member 22 the insulator 6 terminates, the longer a tracking line which leads from a remote conductor to the conductor 3 along the insulator 6 and through the aperture 9 will be, and the more difficult it will be for a corresponding tracking electric arc to form.

During operation, the electric current circulates in the conductor 3 as far as the apertures 8, then passes via the spacing member 22 or the connector 13 associated with the aperture towards an electrical component depending on the manner in which the component is fixed to the connector 13.

A terminal of an electrical component may be fixed to a connector 13 in various manners. Two methods for fixing a component to a connector 13 of the intermediate conductor assembly 2b are described below.

As illustrated in FIG. 4, according to a first method of fixing, an electrical component 31, only one connection terminal of which can be seen, is fixed to the connector 13 by means of fixing elements which comprise a screw 32 and a support washer 33.

The component 31 is supported on the second end 15 of the connector 13. The screw 32 comprises a rod 34 which extends through the bore of the connector 13, a free end of the screw 32 being screwed into a threaded hole 35 of the component 31. At the side of the connector 13 facing away from the component 31, the screw 32 comprises a head 36. The washer 33 is fitted on the rod 34 axially between the head 36 and the spacing member 22.

When the screw 32 is tightened, the head 36 moves into abutment, by means of the washer 33, with the raised support zone 23 of the spacing member 22. The washer 33 which is supported on the spacing member 22 is not at risk of moving into abutment with the first insulator 6 or damaging it.

In this fixing method, the current is transmitted from the conductor 3 towards the component 31 substantially by the connector 13.

As illustrated in FIG. 4, it is possible to provide a spacing member 22 having a smaller diameter than that of the washer 33 and consequently to obtain a more extensive covering of the conductor 3 by the insulator 6.

In FIG. 5, according to a second fixing method, the screw 32 and the washer 33, at one side, and the component 31, at the other side, are transposed. That is to say, the component 31 is arranged at the side of the first end 14 of the connector, supported on the support zone 23 of the spacing member 22, and the screw 32 and the washer 33 are arranged at the side of the second end 15, supported on this end 15.

In this case, the electric current is transmitted from the conductor 3 to the component 31 directly via the spacing member 22. Therefore, there is provided a spacing member 22 of a material which conducts electricity, for example, a metal material.

In the embodiment illustrated, the spacing member 22 which is pushed with force onto the connector 13 which has itself been pushed with force into the aperture 8, is fixedly joined in terms of rotation to the conductor 3. This prevents the spacing member 22 or the connector 13 from being displaced in terms of rotation relative to the conductor 3 on which it is supported when a screw 32 is tightened.

A displacement in terms of rotation could damage the surfaces which are in contact belonging to the conductor 3 and the spacing member 22 and have a detrimental effect on a contact having a low level of electrical resistance being obtained.

Preferably, the adjustments between the connector 13 and the conductor 3 and between the spacing member 22 and the connector 13 are such that the torque which must be applied to the spacing member 22 or the connector 13 in order to displace one and/or the other in terms of rotation about the axis A is greater than 15 N.m. This prevents the rotation of the spacing member 22 and/or the connector 13, in particular in applications in which the spacing member 22 or the connector 13 have an outer diameter of approximately 20 mm.

In a variant which allows the immobilisation in terms of rotation to be improved, the aperture 8 and the connector 13 and/or the spacing member 22 and the connector 13 have complementary radial reliefs. For example, the connector 13 comprises tongues which extend axially and which together form hollow members and the aperture 8 comprises projections which extend radially inwards into the hollow members.

The connectors 13 can be distributed in order to produce any type of electric circuit. In particular, connectors 13 can be associated in groups of three in order to connect electrical components having three poles, such as transistors.

1. Electric conductor assembly, of the type comprising:
an electric conductor in the form of a plate having a first surface and a second surface and comprising an aperture which extends through the conductor between these surfaces along an axis,
a first spacing member which is supported on the first surface at the periphery of the aperture, and
a second spacing member which is supported on the second surface at the periphery of the aperture,
characterised in that it comprises centering means for centering and immobilising the first and second spacing members radially relative to the aperture.

2. Assembly according to claim 1, characterised in that the centering means comprise a portion of the second spacing member that protrudes from the aperture at the side of the first surface the first spacing member being engaged on the portion.

3. Assembly according to claim 2, wherein the first spacing member is fitted on an outer surface of the portion.

4. Assembly according to claim 2, wherein the first spacing member is force-fitted on the portion.

5. Assembly according to claim 2, wherein the portion has a shape which complements that of the aperture and extends through the aperture in order to allow the second spacing member to be centered relative to the aperture.

6. Assembly according to claim 5, wherein the portion of the second spacing member is force-fitted in the aperture.

7. Assembly according to claim 1, wherein the conductor, the second spacing member and the first spacing member form a fixedly joined assembly.

8. Assembly according to claim 1, comprising at least one insulator which covers a surface of the conductor, the insulator having an opening in the region of the aperture and providing an exposed support zone between the aperture and the insulator, the spacing member which is supported on the surface moving into abutment with this exposed support zone.

9. Assembly according to claim 8, wherein the opening has a diameter which is substantially equal to or greater than the diameter of the spacing member.

10. Assembly according to claim 1, wherein the centering means allow the spacing members to be immobilised in terms of rotation about the axis, relative to each other and relative to the aperture.

11. Assembly according to claim 10, wherein the maximum resistance torque relative to the rotation of the centering means of the spacing members is greater than 15 N.m.

12. Electrical device, comprising an assembly according to claim 1, and a tie rod which extends axially through the spacing members, a support washer which is held in abutment with either the first spacing member or the second spacing member by the tie rod, and an electrical component which is held in abutment with the other of the first spacing member or second spacing member.

13. Electrical connection system, comprising a plurality of electric conductor assemblies according to claim 1.
